(19) United States
(12) Patent Application Publication
(10) Pub. No.: US 2026/0089685 A1
(43) Pub. Date: Mar. 26, 2026

(54) ENERGY RESOURCE LEVEL BASED PAGING RESPONSE

(71) Applicant: Nokia Technologies Oy, Espoo (FI)

(72) Inventors: Navin HATHIRAMANI, Dallas, TX (US); Mikko SÄILY, Espoo (FI)

(21) Appl. No.: 19/106,744

(22) PCT Filed: Aug. 1, 2023
(86) PCT No.: PCT/IB2023/057806

§ 371 Date: Feb. 26, 2025

Related U.S. Application Data
(60) Provisional application No. 63/402,290, filed on Aug. 30, 2022.

(51) Int. Cl. H04W 68/02; H04B 17/318

(52) U.S. Cl. CPC H04W 68/02; H04B 17/328

(57) ABSTRACT

Systems, methods, apparatuses, and computer program products for responding to paging based on energy resource level are provided. For example, a method can include receiving a paging from a network. The paging can include a paging attempt number indicating a number of times a given paging has been attempted. The method can also include initiating a delay. The delay can be at least partially based on the paging attempt number and on an energy level of a user equipment, such as an energy harvesting device. The method can additionally include responding to the paging upon completion of the delay.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to responding to paging based on energy resource level.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on 5G new radio (NR), but a 5G (or NG) network can also build on the E-UTRA radio. From release 18 (Rel-18) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to an apparatus. The apparatus can include at least one processor and at least one memory storing instructions. The instructions, when executed by the at least one processor, can cause the apparatus at least to perform receiving a paging from a network. The paging can include a paging attempt number indicating a number of times a given paging has been attempted. The instructions, when executed by the at least one processor, can also cause the apparatus at least to perform initiating a delay. The delay can be at least partially based on the paging attempt number and on an energy level of the apparatus. The instructions, when executed by the at least one processor, can further cause the apparatus at least to perform responding to the paging upon completion of the delay.

An embodiment may be directed to an apparatus. The apparatus can include at least one processor and at least one memory storing instructions. The instructions, when executed by the at least one processor, can cause the apparatus at least to perform sending a paging to a user equipment, wherein the paging comprises a paging attempt number indicating a number of times a given paging has been attempted. The instructions, when executed by the at least one processor, can cause the apparatus at least to perform receiving a response to the paging from the user equipment.

An embodiment may be directed to a method. The method can include receiving, a paging from a network at a user equipment. The paging can include a paging attempt number indicating a number of times a given paging has been attempted. The method can also include initiating a delay wherein the delay is at least partially based on the paging attempt number and on an energy level of the user equipment. The method can further include responding to the paging upon completion of the delay.

An embodiment may be directed to a method. The method can include sending a paging to a user equipment from a network. The paging can include a paging attempt number indicating a number of times a given paging has been attempted. The method can also include receiving a response to the paging from the user equipment.

An embodiment can be directed to an apparatus. The apparatus can include means for receiving a paging from a network. The paging can include a paging attempt number indicating a number of times a given paging has been attempted. The apparatus also includes means for initiating a delay wherein the delay is at least partially based on the paging attempt number and on an energy level of the apparatus. The apparatus further includes means for responding to the paging upon completion of the delay.

An embodiment can be directed to an apparatus. The apparatus can include means for sending a paging to a user equipment. The paging can include a paging attempt number indicating a number of times a given paging has been attempted. The apparatus can also include means for receiving a response to the paging from the user equipment.

### BRIEF DESCRIPTION OF THE DRAWINGS

For proper understanding of example embodiments, reference should be made to the accompanying drawings, wherein:

FIG. 1 illustrates an example of energy harvesting device energy resources depletion during a paging procedure;

FIG. 2 illustrates an energy harvesting device aware of a paging attempt number, according to certain embodiments;

FIG. 3 illustrates a flow chart of a paging handling procedure for energy harvesting devices, according to certain embodiments; and

FIG. 4 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing responding to paging based on energy resource level, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Low cost and low power devices for wide area Internet of things (IoT) communication may benefit many IoT applications. These use cases may be addressed by work of the third generation partnership project (3GPP) with regard to narrowband IoT (NB-IoT)/enhanced machine type communication (eMTC) and new radio (NR) reduced capability (RedCap). These IoT devices may consume tens or hundreds of milliwatts power during transceiving and may cost a few dollars. To achieve the objects of internet of everything, IoT devices with ten or even a hundred times lower cost and power consumption may be valuable, especially for a large number of applications that may rely on devices without batteries, sometimes referred to as batteryless or battery-free devices. There may be benefit in IoT technology that can support batteryless devices.

The number of IoT connections has been growing rapidly in recent years and may be hundreds of billions by 2030. With more and more things expected to be interconnected for improving production efficiency and increasing the comforts of life, there may be an increasing benefit from further reduction of size, cost, and power consumption for IoT devices. In particular, regular replacement of batteries for all the IoT devices may be impractical due to the tremendous consumption of material and labor. One option is to use energy harvested from environments to power IoT devices for self-sustainable communications, especially in applications with a huge number of devices, such as ID tags and sensors.

In the target use cases, there may be challenges in providing the capability of cooperating with energy harvesting considering limited device size. Cellular devices may consume tens or even hundreds of milliwatts power for transceiving processing. Taking an NB-IoT module for example, the typical current absorption for receive processing is currently about 60 mA, with a supply voltage higher than 3.1 V, and 70 mA for transmitting processing at 0 dBm transmit power. The output power provided by typical energy harvester may be below 1 milliwatt, considering the small size of a few square centimeters for practical devices. Since the available power is far less than the consumed power, it may be impractical to power cellular devices directly by energy harvesting in most cases.

One possible solution is to integrate energy harvesting with a rechargeable battery or supercapacitor. Both rechargeable batteries and supercapacitors may suffer from shortened lifetime in practical cases. It may be hard to provide constant charging current or voltage by energy harvesting, but longtime continuous charging may be needed, due to the very small output power from an energy harvester. Varying charging current and long term continuous charging may both be harmful to battery life. For a supercapacitor, its lifetime may be significantly reduced in high temperature environments. For example a supercapacitor may function properly for less than 3 years at 50 degrees Celsius.

Another impact may be that device size may be significantly increased. Small size button batteries may only provide current of a few tens of milliamps. Thus, batteries with a much larger size, such as AA batteries, may be used to power cellular devices. In this case, the size of the battery may be even larger than the active portions of the module itself. To store energy for a proper duration of working, such as one second, the required capacitance of a supercapacitor may be at the level of a hundred milli-farads. The size of such supercapacitors may likewise be larger than the size of an NB-IoT module aside from the power source.

Rechargeable batteries and supercapacitors can each be more expensive than the module itself. Even purchased in large quantities, the cost of a suitable battery or supercapacitor may reach one or a few dollars, which may nearly double the cost of the device.

Radio-frequency identifier (RFID) is a technology that supports batteryless tags, which is one category of batteryless device. The power consumption of commercial passive RFID tags can be as low as 1 microwatt. A technique that enables such low power consumption can be envelope detection for downlink data reception, and backscatter communication for uplink data transmission. RFID is designed for short-range communications, and typical effective range is less than 10 meters. As the air interface of RFID has remained almost unchanged since 2005, the transmission scheme may be an obstacle to improving link budget and capability of supporting a scalable network. Nevertheless, RFID can demonstrate the extremely low power consumption of backscatter communication.

Passive IoT may be included in 5G NR. Both 3GPP and non-3GPP technologies, such as WiFi, Bluetooth, UWB, and LORA may benefit from techniques that provide low power consumption. A few or tens of microwatts power consumption can be achieved for passive tags based on or with modifications to each of these air interfaces. In contrast to RFID, there may be benefit in providing devices with long range communication capability. For example, a distance of a few hundred meters may be possible.

Certain types of user equipment (UE), such as energy harvesting devices (EHDs), may harvest energy from natural sources. The natural sources can include solar energy, environmental vibrations, or the like. The amount of harvested energy and stored energy may vary from device to device. The harvested energy does not need to be exclusively for the device's radio frequency (RF) modem. For example, the harvested energy could also be employed to power sensors on the device. Certain embodiments may help a network to support devices with reduced energy resources and with a high variability of the energy resources.

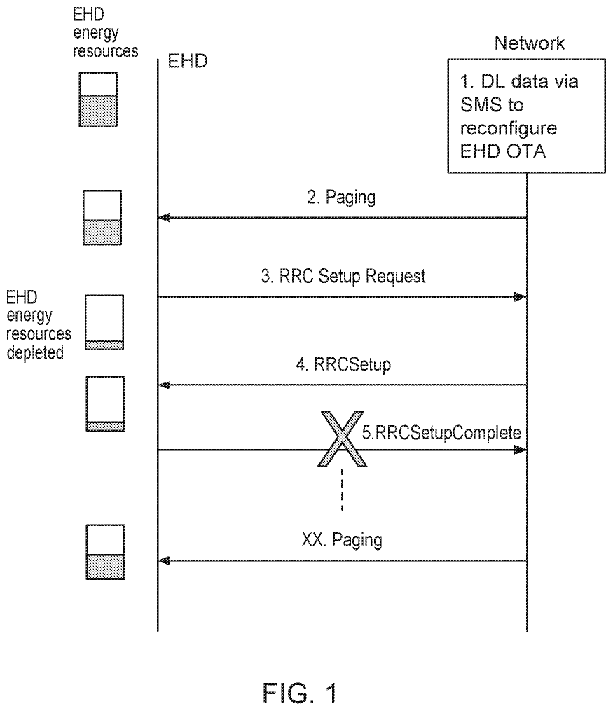

FIG. 1 illustrates an example of energy harvesting device energy resources depletion during a paging procedure. The left side of FIG. 1 illustrates an energy level of a battery, a supercapacitor, and/or another type of energy resource, while the right side of FIG. 1 illustrates signaling that is to occur.

For example, at 1 the network may have downlink data to deliver via short message system (SMS) to reconfigure the EHD over-the-air (OTA). When a device is paged at 2, the network may expect the device to be capable of monitoring the physical downlink control channel (PDCCH) and to provide a paging response in addition to carrying out the follow up procedures for which the paging was initiated. An EHD may not have enough energy resources to complete the needed monitoring and/or procedures related to the reason for which the EHD was paged. For example, the EHD may have enough energy to send an RRC setup request at 3 and to monitor for a RRC setup message at 4, but may lack sufficient energy to send an RRC setup complete message at 5. After harvesting more energy, the same cycle may repeat subsequently at a subsequent paging instance, shown as XX in FIG. 1.

It may be beneficial to avoid dropping calls due to energy depletion of EHD. Because the procedure is dropped, when further paging arrives at XX, the previously received and transmitted messages at 2-4 may not be leveraged by the EHD, and consequently the EHD may have the same energy drain issues as before. Phrased differently, there is not an opportunity in this approach for the EHD to harvest the necessary energy to complete the RRC setup.

Certain embodiments may ensure that an EHD that responds to paging procedures can complete paging and the follow up procedures successfully. Certain embodiments provide a framework addressing when the EHD should transition from low activity state, for example RRC idle/inactive, to ready to communicate, for example RRC connected, based on the EHD's harvested energy levels.

Without certain embodiments, for UEs in RRC Idle, the access and mobility management function (AMF) may provide each NG-RAN node with paging attempt information that includes a paging attempt count and an intended number of paging attempts, as well as a next paging area scope. For UEs in RRC inactive, the serving NG-RAN node may also provide RAN paging attempt information. Each paged NG-RAN node can receive the same RAN paging attempt information during a paging attempt with the following content: paging attempt count, the intended number of paging attempts, and the next paging area scope. For mobile initiated connection only (MICO) with active time, the AMF can determine the active time during registration.

As part of a service request procedure, the mobility management entity (MME) in long term evolution (LTE) may include a paging priority information with a paging message. In LTE, the paging priority indication may only be included if the priority level is associated with a priority service, as configured by the operator policy. During a congestion situation, the evolved Node B (eNodeB or eNB) may prioritize the paging of UEs according to the paging priority indications. Thus, the paging priority in LTE and as described in 3GPP technical specification (TS) 23.401 relates to how the function of the eNB as opposed to the function of a user equipment or EHD when responding to the paging.

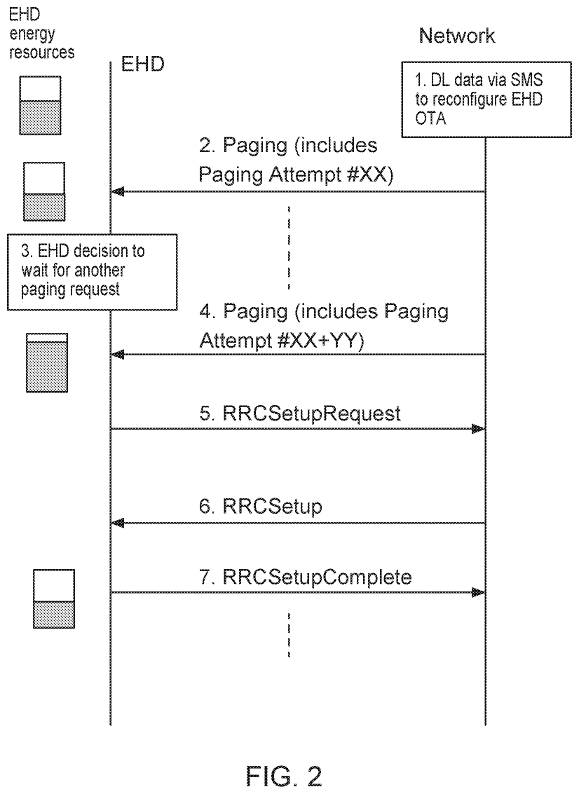

FIG. 2 illustrates an energy harvesting device aware of a paging attempt number, according to certain embodiments. In FIG. 2, the left side illustrates energy level of an EHD, while the right side illustrates a signal flow between the EHD and the network. At 1, the network may have downlink data to be transmitted via short message system message to configure the EHD over the air. At 2, therefore, the network can send a paging toward the EHD. The paging can include an indication of a current paging attempt. For example, this may be the first paging attempt, so the paging attempt number could be 001. In FIG. 2, the paging attempt is indicated as #XX. The EHD may detect this paging attempt and, at 3, may initiate a delay or make a decision to wait for another paging request (e.g., due to an insufficient energy level and/or another factor as described in detail elsewhere herein). Subsequently, at 4 (e.g., when the energy level in the EHD has sufficiently increased), the network may make another paging attempt for this same paging. This may or may not be the next paging attempt. For example, if this is the second paging attempt, the paging attempt number may 002. By contrast, if this is the nineteenth paging attempt, the paging attempt number may be 019. In FIG. 2, the paging attempt is indicated as #XX+YY, where YY is the number of paging attempts since the paging attempt at 2.

As shown in FIG. 2, by 4, the energy level in the EHD may have sufficiently increased, thereby enabling the EHD to respond to the paging attempt at 5, by sending an RRC setup request. Accordingly, at 6, the network may provide an RRC setup message, and at 7, the EHD may confirm with an RRC setup complete message. In this case, because the EHD waited YY paging attempts, there was sufficient energy for the EHD to complete the RRC setup successfully.

As illustrated by way of example in FIG. 2, certain embodiments enhance the paging procedure such that the EHD is aware of where the network is within the paging procedure so that the EHD device can decide when to respond to a paging procedure based on an amount of currently harvested energy. For example, the provision of the paging attempt number may inform the EHD as to how many paging attempts are remaining. For example, the EHD may know in advance the maximum number of paging attempts that the network will make. The EHD may not necessarily detect the first paging attempt and consequently may not be able to assume that the first detected paging attempt is the first paging attempt from the network's standpoint. For example, the first paging attempt detected by the EHD may be the fifth paging attempt. The EHD may know that the maximum number of paging attempts is 100. In such a case, the EHD may understand that there are still 95 paging attempts. Accordingly, the EHD may be able to initiate a delay or decide to wait to respond to a later paging. In practice, the number of maximum attempts may be lower, such as 5.

The EHD also may know the time between paging attempts. This may be a fixed number or this time may be derivable from knowing the paging type, the paging priority, and/or other information.

The EHD may determine the delay or calculate how long to wait based on the amount of energy required to successfully complete the paging and its associated follow up procedures. The delay can be understood as a time-offset between a start time to wait for energy required to successfully complete the paging and its associated follow up procedures and a start time to start the follow up procedure. The time offset may be understood for example as a timer with time offset value in seconds, number of symbols, number of frames, number of paging events, or the like. The amount of energy required to successfully complete the paging and its associated follow up procedures can be estimated by the EHD considering the serving cell RSRP and the paging type and/or priority field, which may also be provided in the paging message. The paging priority field can also be an indicator of the immediateness with which the EHD should provide a paging response. Calculating or otherwise deciding how long to wait can involve comparing the energy level of the EHD to a predetermined threshold for paging responses. The predetermined threshold for paging responses can be determined based on an estimate of power required for establishing a radio resource control connection and sending an amount of data that is associated with the paging type indicator. The predetermined threshold can be determined solely by the EHD or with the assistance of the network.

In the example of FIG. 2, the network (NW) can attempt to page an EHD with the intention of delivering the EHD an SMS to reconfigure the EHD over the air. Upon the reception of the paging indication, the EHD energy resources can be in an orange state. The orange state can refer to a situation in which the EHDs tends towards low amounts of energy (e.g., energy levels that are potentially insufficient to complete a given paging procedure). Based on the paging attempt number, the paging type and the priority, the EHD can initiate a delay at least partially based on the paging attempt number and an energy level of the EHD and decide to wait prior to responding to the paging attempt with the intent to harvest some more energy before responding. After another YY paging attempts, the EHD resources may be in a green state. The green state can refer to a situation in which there are sufficient resources (e.g., energy levels that are sufficient to complete a given paging procedure). In this state, the EHD can respond to the paging procedure following normal 3GPP procedures. At the network side, there may be a timer associated with a last paging attempt before proceeding to declare an EHD unreachable. This timer may take into account the possibility that the EHD may delay a response to harvest more energy.

In certain embodiments, the network can provide EHD paging records with a paging attempt number and a paging type, a paging priority, or both a paging type and a paging priority. The network can semi-statically configure the EHD with the max number of paging attempts and time between attempts. The EHD can employ paging procedure assistance information, such as the paging attempt number, paging type, and paging priority, as well as the EHD's harvested energy level to decide when to respond to a paging message.

Certain embodiments may apply to a case where the EHD is in RRC idle state and paged by the AMF. Also, certain embodiments may apply to a case where the EHD is in RRC inactive state and paged by the next generation radio access network (NG-RAN). Some other embodiments may apply to a case where the paging is used to notify the EHD in idle, inactive, or connected state of the state of system information change. In yet another embodiment, the paging may be for only one specific UE, and in further embodiments the paging may apply to all UEs which are for example in a certain area (e.g., tracking area, location area, or routing area).

The network may include the additional fields of paging attempt number, paging priority, and/or paging type only for paging records associated with EHD. The network may identify whether a given UE is an EHD based on UE capabilities information.

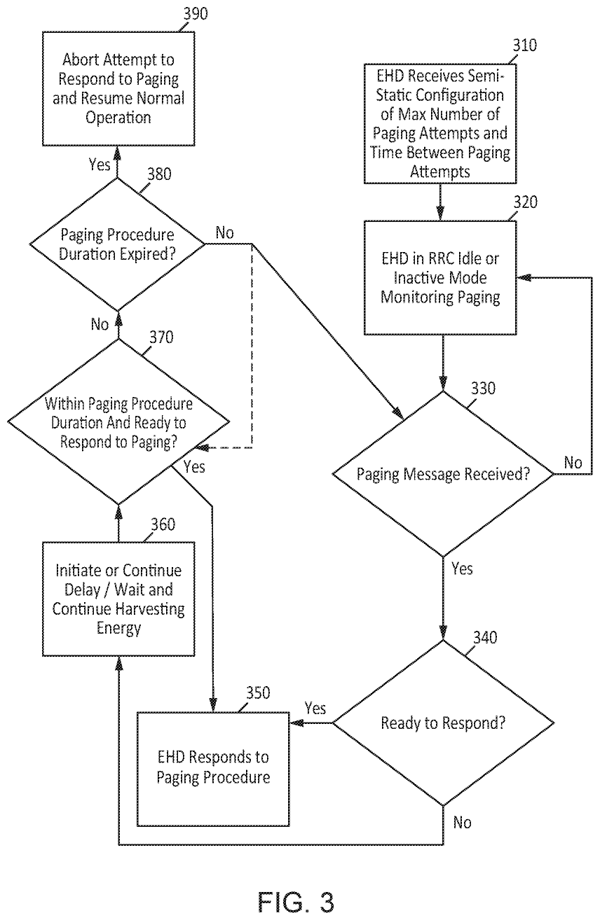

FIG. 3 illustrates a flow chart of a paging handling procedure for energy harvesting devices, according to certain embodiments. More specifically, the EHD behavior is illustrated in FIG. 3.

As shown at 310, the EHD can receive a semi-static configuration of a paging procedure. This configuration can inform the EHD as to at least the maximum number of paging attempts and the time between paging attempts. This information can be provided various ways: via system information messages using broadcast, by common control signaling, by group-common control signaling, or by unicast for EHD in RRC connected mode.

At 320, the EHD in RRC idle or RRC inactive state can be monitoring for paging occasions. While in RRC connected state, the EHD may monitor the paging channels in any paging occasion signaled in system information for a system information change indication and a public warning system notification. While in RRC idle, the UE may monitor the paging channels for core network (CN)-initiated paging. While in RRC inactive, the UE may monitor paging channels for RAN-initiated paging and CN-initiated paging. At 330, a paging message addressed to the EHD enhanced with at least the paging attempt number and the paging type and/or priority can be received, corresponding to the Yes branch. If a paging message is not received, corresponding to the No branch, the EHD can continuing monitoring for the paging message and determining, at 330, whether the paging message is received.

At 340, the EHD can decide whether the EHD should respond to the paging message or initiate a delay. This decision at 340 can be based on the EHD's harvested energy levels, the paging type, and/or the paging priority. The decision at 340 can also or alternatively take into account any previously determined delay or waiting period that the EHD has initiated or otherwise decided. If the EHD chooses to respond, corresponding to the Yes branch of 340, the EHD can proceed to 350 and follow any desired procedures for responding to a paging, such as those discussed above.

If the EHD chooses not to respond to this paging occasion, corresponding to the No branch of 340, the EHD can, at 360, initiate a delay, for example wait for a specific amount of time prior to responding to the paging procedure or until the next paging message. The objective of such a delay or waiting may be to harvest additional energy. If a delay or other wait is already in progress, the EHD can continue the delay or wait. Furthermore, if the EHD is aware of the paging attempt number, the total number of paging attempts that will be attempted by the network (e.g., NG-RAN node), and the time between paging messages, the EHD may decide to refrain from further decoding any paging messages in order to save additional energy sufficient to respond to the paging message and its associated procedures. In some examples, the EHD may be aware of just the time before the network or paging cell declares the EHD unreachable prior to deciding to refrain from decoding other re-paging attempts for a period of time.

At 370, after a wait or delay, the EHD can determine whether the EHD is still within a paging procedure duration and ready to respond to the paging. If so, the EHD can respond to the paging at 350. Otherwise, at 380, the EHD can determine whether the paging procedure duration has expired. If no, then the EHD can check whether a paging message is received at 330. As another option, shown as a broken line in FIG. 3, if the EHD is aware of the paging attempt number, the total number of paging attempts that will be attempted by the network, and the time between paging messages, the EHD may decide to refrain from further decoding any paging messages in order to save additional energy sufficient to respond to the paging message and its associated procedures, thus returning directly to 370. If the paging procedure duration has expired, at 390 the EHD can abort any attempt to respond to the paging and may resume normal operations.

If the paging message indicates high priority paging, the EHD may prioritize completing the paging procedure over other functions defined for the EHD.

EHD behavior for when the paging attempt number indicates that the current paging is the last paging could be semi-statically configured per paging type/priority at 310. Additionally, rather than or in addition to transmitting a current paging number and configuring a maximum number of paging attempts, the network may provide a one bit indicator or another suitable indication of whether the current paging attempt is the last paging attempt.

The decision at 340 regarding the sufficiency of an energy level to respond to a paging message can be variously implemented. For example, the decision at 340 may be based on previous attempts where the energy has been sufficient for completing the paging procedure. As another option, the decision at 340 may be based on a mapping, which could either be semi-statically configured or specified via a preconfigured rule. For example, for a first paging type, paging type 1, the estimated number of downlink (DL) messages assuming a specific modulation and coding scheme (MCS) for DL and a single spatial later may be 10. Likewise, for paging type 1, the estimated number of uplink (UL) messages assuming a specific MCS for UL and a single spatial layer may also be 10. By contrast, for paging type 2, the estimated number of DL messages for the specific MCS for DL may be 20 and the estimated number of UL messages for the specific MCS for UL may be 20.

If such a pattern holds true for other paging types, the EHD may be able to calculate the number of UL and DL messages by multiplying the paging type by 10, rather than by looking up the values from a table, or the like.

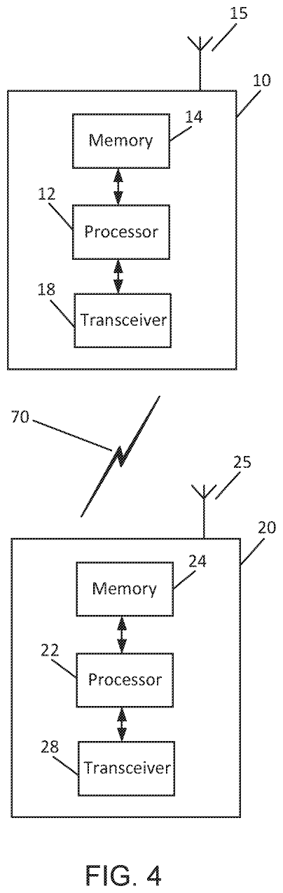

FIG. 4 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 4.

As illustrated in the example of FIG. 4, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 4, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to responding to paging based on energy resource level.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein. The term “non-transitory,” as used herein, may correspond to a limitation of the medium itself (i.e., tangible, not a signal) as opposed to a limitation on data storage persistency (e.g., RAM vs. ROM).

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more ˜αantennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-3, or any other method described herein. In some embodiments, as discussed herein, apparatus 10 may be configured to perform a procedure relating to providing responding to paging based on energy resource level, for example.

FIG. 4 further illustrates an example of an apparatus 20, according to an embodiment. In an embodiment, apparatus 20 may be a node or element in a communications network or associated with such a network, such as a UE, EHD, communication node, mobile equipment (ME), mobile station, mobile device, stationary device, IoT device, or other device. As described herein, a UE or an EHD may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 4.

As illustrated in the example of FIG. 4, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, EHD, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-3, or any other method described herein. For example, in an embodiment, apparatus 20 may be controlled to perform a process relating to providing responding to paging based on energy resource level, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may allow a network and/or service provider to configure how different energy harvesting device types and capabilities can respond to paging and connection requests. Also, certain embodiments may allow energy harvesting devices to better decide how to efficiently utilize their scarce energy resources. Certain embodiments may avoid paging storms and repetitive dropped call procedures from the energy harvesting devices. Furthermore, certain embodiments may provide efficient utilization of network resources.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components that, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

AMF: Access and Mobility Management Function
DL: Downlink
EHD: Energy Harvesting Device
IoT: Internet of Things
MICO: Mobile Initiated Connection Only
NG-RAN: Next Generation RAN
OTA: Over the Air
PDCCH: Physical Downlink Control Channel
RAN: Radio Access Network
RRC: Radio Resource Control
SMS: Short Message Service

1.-59. (canceled)

60. An energy harvesting device (EHD) comprising:
at least one processor; and
at least one memory storing instructions that, when executed by the at least one processor, cause the EHD at least to perform the following operations:
while the EHD is in radio resource control idle state:
receiving a configuration of a paging procedure, the configuration indicating a maximum number of paging attempts that can be attempted for the paging procedure;
receiving, from a network, a paging message comprising a paging attempt number indicating a number of times a paging has been attempted for the paging procedure, a paging type, and a paging priority;
determining an amount of energy required to successfully complete the paging procedure and associated follow up procedures based on a serving cell reference signal received power (RSRP), the paging type, and the paging priority;
based on harvested energy levels of the EHD being insufficient compared to the determined amount of energy required to successfully complete the paging procedure and associated follow up procedures:
determining to not respond to the paging message; and
initiating a delay before responding to a page of the paging procedure;
calculating a specific amount of time for the delay based on the following: current harvested energy levels of the EHD, the determined amount of energy required to successfully complete the paging procedure and associated follow up procedures, a time between paging attempts for the paging procedure, the paging attempt number from the paging message, and the maximum number of paging attempts that can be attempted for the paging procedure;
based on the current harvested energy levels, the determined amount of energy required to successfully complete the paging procedure and associated follow up procedures, the paging attempt number, the maximum number of paging attempts that can be attempting for the paging procedure, and a time between paging messages, determining to refrain from decoding any additional paging messages during the delay to save additional energy;
after the specific amount of time for the delay has completed:
determining the harvested energy levels of the EHD have sufficiently increased to the determined amount of energy required to successfully complete the paging procedure and associated follow up procedures;
receiving, from the network, an additional paging message; and
based on the additional paging message, completing the paging procedure and associated follow up procedures.

61. The EHD of claim 60, wherein the delay is further based on a comparison between the harvested energy levels and a predetermined threshold for paging responses.

62. The EHD of claim 61, wherein the predetermined threshold for paging responses is determined based on an estimate of power required for establishing a radio resource control connection and sending an amount of data associated with the paging type indicator.

63. The EHD of claim 62, wherein the predetermined threshold is determined by the EHD and the network.

64. The EHD of claim 63, wherein the instructions, when executed by the at least one processor, further cause the EHD at least to perform
receiving a paging cells unreachable timer value, wherein calculating the specific amount of time for the delay is further based on the paging cells unreachable timer value.

65. The EHD of claim 64, wherein the time between paging attempts is determined from the paging type and the paging priority.

66. The EHD of claim 65, wherein the paging is received from an access and mobility function entity.

67. A system comprising:
an energy harvesting device (EHD);
at least one processor; and
at least one memory storing instructions that, when executed by the at least one processor, cause the EHD at least to perform the following operations:
while the EHD is in radio resource control idle state:
receiving a configuration of a paging procedure, the configuration indicating a maximum number of paging attempts that can be attempted for the paging procedure;
receiving, from a network, a paging message comprising a paging attempt number indicating a number of times a paging has been attempted for the paging procedure, a paging type, and a paging priority;
determining an amount of energy required to successfully complete the paging procedure and associated follow up procedures based on a serving cell reference signal received power (RSRP), the paging type, and the paging priority;
based on harvested energy levels of the EHD being insufficient compared to the determined amount of energy required to successfully complete the paging procedure and associated follow up procedures:
determining to not respond to the paging message; and
initiating a delay before responding to a page of the paging procedure;
calculating a specific amount of time for the delay based on the following: current harvested energy levels of the EHD, the determined amount of energy required to successfully complete the paging procedure and associated follow up procedures, a time between paging attempts for the paging procedure, the paging attempt number from the paging message, and the maximum number of paging attempts that can be attempted for the paging procedure;
based on the current harvested energy levels, the determined amount of energy required to successfully complete the paging procedure and associated follow up procedures, the paging attempt number, the maximum number of paging attempts that can be attempting for the paging procedure, and a time between paging messages, determining to refrain from decoding any additional paging messages during the delay to save additional energy;
after the specific amount of time for the delay has completed:
determining the harvested energy levels of the EHD have sufficiently increased to the determined amount of energy required to successfully complete the paging procedure and associated follow up procedures;
receiving, from the network, an additional paging message; and
based on the additional paging message, completing the paging procedure and associated follow up procedures.

68. The system of claim 67, wherein the delay is further based on a comparison between the harvested energy levels and a predetermined threshold for paging responses.

69. The system of claim 68, wherein the predetermined threshold for paging responses is determined based on an estimate of power required for establishing a radio resource control connection and sending an amount of data associated with the paging type indicator.

70. The system of claim 69, wherein the predetermined threshold is determined by the EHD and the network.

71. The system of claim 70, wherein the instructions, when executed by the at least one processor, further cause the EHD at least to perform
receiving a paging cells unreachable timer value, wherein calculating the specific amount of time for the delay is further based on the paging cells unreachable timer value.

72. The system of claim 71, wherein the time between paging attempts is determined from the paging type and the paging priority.

73. The system of claim 72, wherein the paging is received from an access and mobility function entity.

74. A method comprising:
while an energy harvesting device (EHD) is in radio resource control idle state:
receiving, by the EHD, a configuration of a paging procedure, the configuration indicating a maximum number of paging attempts that can be attempted for the paging procedure;
receiving, by the EHD from a network, a paging message comprising a paging attempt number indicating a number of times a paging has been attempted for the paging procedure, a paging type, and a paging priority;
determining, by the EHD, an amount of energy required to successfully complete the paging procedure and associated follow up procedures based on a serving cell reference signal received power (RSRP), the paging type, and the paging priority;
based on harvested energy levels of the EHD being insufficient compared to the determined amount of energy required to successfully complete the paging procedure and associated follow up procedures:
determining, by the EHD, to not respond to the paging message; and
initiating, by the EHD, a delay before responding to a page of the paging procedure;
calculating, by the EHD, a specific amount of time for the delay based on the following: current harvested energy levels of the EHD, the determined amount of energy required to successfully complete the paging procedure and associated follow up procedures, a time between paging attempts for the paging procedure, the paging attempt number from the paging message, and the maximum number of paging attempts that can be attempted for the paging procedure;
based on the current harvested energy levels, the determined amount of energy required to successfully complete the paging procedure and associated follow up procedures, the paging attempt number, the maximum number of paging attempts that can be attempting for the paging procedure, and a time between paging messages, determining, by the EHD, to refrain from decoding any additional paging messages during the delay to save additional energy;
after the specific amount of time for the delay has completed:
determining, by the EHD, the harvested energy levels of the EHD have sufficiently increased to the determined amount of energy required to successfully complete the paging procedure and associated follow up procedures;
receiving, by the EHD from the network, an additional paging message; and
based on the additional paging message, completing, by the EHD, the paging procedure and associated follow up procedures.

75. The method of claim 74, wherein the delay is further based on a comparison between the harvested energy levels and a predetermined threshold for paging responses.

76. The method of claim 75, wherein the predetermined threshold for paging responses is determined based on an estimate of power required for establishing a radio resource control connection and sending an amount of data associated with the paging type indicator.

77. The method of claim 76, wherein the predetermined threshold is determined by the EHD and the network.

78. The method of claim 77, further comprising:
receiving a paging cells unreachable timer value, wherein calculating the specific amount of time for the delay is further based on the paging cells unreachable timer value.

79. The method of claim 78, wherein the time between paging attempts is determined from the paging type and the paging priority.
